(19) United States
(12) Patent Application Publication
(10) Pub. No.: US 2013/0181431 A1
(43) Pub. Date: Jul. 18, 2013

(54) SELF-STEERING AGRICULTURE GRAIN CARTS AND MANURE TANKS

(71) Applicant: BALZER, INC., Mountain Lake, MN (US)

(72) Inventors: Randy M. McMahon, Lakeville, MN (US); Frank D. Bazzoli, St. James, MN (US); Donald R. Marcy, Bingham Lake, MN (US)

(73) Assignee: BALZER, INC., Mountain Lake, MN (US)

(21) Appl. No.: 13/739,385

(22) Filed: Jan. 11, 2013

Related U.S. Application Data
(63) Continuation-in-part of application No. 12/689,903, filed on Jan. 19, 2010.

(51) Int. Cl. B62D 55/065; B60P 3/22; B60P 3/00; B62D 11/20

(52) U.S. Cl. CPC B62D 55/065; B62D 11/20; B60P 3/2205; B60P 3/00
USPC 280/839; 280/28.5

(57) ABSTRACT

A frame and undercarriage track mounted assembly for a grain cart or manure tank unit designed to be pulled in a forward direction over and agricultural field by a farm tractor is disclosed. The invention involves a steering axle assembly that is adapted to turn dual spaced track assemblies. The steering axle is easily guided to improve the maneuverability and safety of the unit and reduce field compaction. The steering system design features compound angled kingpins that transfer some of the unit weight to assist in turns. Thus, the steering system reduces the resistance of the unit steering system to turning and the large footprint of the track assemblies minimizes ground compaction during turns.

### CROSS-REFERENCED TO RELATED APPLICATIONS

This application is a continuation-in-part of application Ser. No. 12/689,903, filed Jan. 19, 2010, entitled “SELF-STEERING AGRICULTURE GRAIN CARTS AND MANURE TANKS”, and which is deemed incorporated herein by reference in its entirety.

### STATEMENT REGARDING FEDERALLY SPONSORED RESEARCH OR DEVELOPMENT

Not applicable

### BACKGROUND OF THE INVENTION

I. Field of the Invention

The present invention relates generally to heavy agricultural vehicles that are not self-propelled, including grain carts used in harvesting grain crops and manure tanks, all of which are designed to be pulled behind farm tractors. More particularly, the invention relates to a steering axle assembly designed for grain carts and manure tank trailers that facilitates turning and maneuverability while minimizing soil loading and compaction.

II. Related Art

Non-motorized trailer-mounted agriculture utility vehicles in the form of grain carts and manure tanks that are designed to be pulled behind motorized vehicles, specifically farm tractors, have been used for a long period of time. Grain carts are typically used in combination with various types of combines in grain-harvesting operations in which the grain is separated from stalks in threshing and separation steps and is first collected in a grain tank in the combine from which it is discharged through a grain tank unload tube into a grain cart pulled alongside the combine. Large capacity and easy maneuverability are desirable attributes for such grain carts inasmuch as this increases the efficiency of the grain harvesting operation. While increased capacity for grain carts is desirable, it is also desirable that the implements minimize the degree to which the soil in the field is compacted by the cart, particularly when the cart is fully loaded. An example of such a cart is shown in U.S. Pat. No. 6,488,114 B1 to McMahon et al.

Manure tanks have also long been used to distribute manure-containing mixtures over large field areas. The tanks, at times, are heavily laden and also must be highly maneuverable and need to have a minimum impact in terms of soil compaction when pulled through a field while applying the tank contents.

One important aspect of pulled grain carts and manure tanks is the ability of such vehicles to maneuver in the field while maintaining a minimum impact on the soil over which they travel. This is directly affected by the design and operation of steerable axles on such vehicles. These vehicles typically include rear-steering axles and fixed front axles in the case of two-axle vehicles and may alternate steering and fixed axles on vehicles which have three or more axles. In addition, these vehicles must have the ability to be easily pulled down roads.

A rear-steering axle assembly which utilizes an offset kingpin arrangement is shown in U.S. Pat. No. 6,267,198 B1. That axle is particularly suited for rear steering on a grain harvesting combine.

Presently, the trend is toward, and the market is demanding, higher and higher capacity grain carts and manure tanks. Whereas, grain carts having a capacity of 1500 bushels were considered high capacity, the size requirement has risen to 2000 bushels or more and manure tanks may have a capacity of 12,000 gallons. Thus, the load carried by the vehicle may be over 50 tons in addition to the weight of the vehicle itself.

While progress has been made, particularly as loads increase, there has developed and remains a need for steering axles that improve the steering function for better maneuverability and safer operation and which also reduce the impact of the vehicle on the soil including field compaction to thereby allow for higher capacity loads.

In addition to wheeled vehicles, systems supporting such vehicles on track assemblies could further reduce the average soil loading thereby reducing soil compaction effects. However, it has not been practical to support heavy grain carts and manure tanks or other large agricultural containers using track-mounted vehicles because of the difficulties in maneuvering tracks in the field as the tracks lack a steering mechanism and must rely on skid steering that severely disturbs the soil under the tracks. Thus, it is also desirable that a system be devised that would enable such heavy agriculture vehicles to be supported on dual track systems that can be steered in a conventional manner.

### SUMMARY OF THE INVENTION

By means of the present invention, there is provided a steerable axle assembly designed for utility agriculture vehicle units in the form of grain carts and manure tanks designed to be pulled in a forward direction over an agricultural field by a motorized farm tractor. The invention involves an axle assembly that is easily guided to improve the maneuverability and safety of the unit and reduce field compaction. The steering system design reduces the amount of weight of the unit concentrated on kingpins and transmitted through the wheels to the ground during turns. Thus, the steering system reduces the resistance of the unit steering system to turning and minimizes ground disturbance and compaction during turns. The steering system improves the performance of rear-steering grain carts and manure tank units having two axles and larger versions of such units with multiple alternating steering and non-steering axles.

One embodiment of the steerable axle assembly of the invention includes a pair of spaced kingpin receiver arrangements supported by a common central axle member, a spindle receiver carried by each kingpin receiver and a spindle mounted in each spindle receiver, each such spindle being adapted to carry a wheel. A kingpin is mounted in each kingpin receiver and each kingpin receiver is disposed in the structure such that a kingpin mounted in the kingpin receiver is positioned at a compound acute angle with the common central axle member, the angle being both directed inward toward the central axle member and rearward of the central axle member. Each of the spindle receivers is mounted to pivot about a kingpin. An arrangement is provided for connecting the spindle receivers together so that they operate in unison. This may be a hydraulic connection or a tie rod arrangement. In a turn, the kingpin angle causes the outward spindle in the turn to travel in an arc that pivots upward and forward to thereby facilitate the turning of the steering axle.

A damping device such as a hydraulic cylinder may be provided to bias the self-steering axle toward a neutral position in which the wheel alignment is returned to a straight ahead direction as the axle assembly comes out of a turn situation.

The self-steering axle assembly of the invention may be paired with a non-steering axle assembly to support a frame for supporting a grain cart or manure tank with the self-steering axle being the rear axle in the assembly. Larger vehicles may be provided with more than one self-steering axle. These include vehicles with three axles in which the front and rear axles are steering axles and the intermediate axle is non-steering and even larger units, for example, ones having four axles wherein the front, second and fourth axles are self-steering and the third axle is non-steering, etc.

In an alternate embodiment, the steering system of at least one steering axle in the grain cart or manure tank unit can incorporate mechanically controlled steering arrangement using a drive line shaft attached to the drawbar of a conveying vehicle such as a tractor.

In a further embodiment, the axle assemblies, particularly the steering axle assemblies, are adapted to be used with track assemblies used to support heavy agriculture vehicles. The track assemblies are designed to be incorporated into heavy vehicles such as dual-track grain cart and manure tank vehicles. The steering axle assemblies for track-mounted vehicles are similar to those of the other embodiments first described above modified to adapt to steer spaced track assemblies in dual track support systems. This enables the use of wide track dual tracks in a steerable arrangement which greatly increase support area to thereby reduce field compaction loading and allow for higher capacity loads.

### BRIEF DESCRIPTION OF THE DRAWINGS

In the drawings wherein like reference characters depict like parts:

FIG. 1 is an exploded view of a steering kingpin system constructed in accordance with the invention;

FIG. 2 is a view of the steering kingpin system of FIG. 1 assembled attached to a fragment of a vehicle frame;

FIG. 3 is a rear elevational view of an assembled steering axle system for a wheeled vehicle with a tie rod connector;

FIG. 4 is a top view of an assembled steering axle system similar to that of FIG. 3 with parts removed for clarity;

FIG. 5 is a rear elevational view of an alternative embodiment of an assembled steering axle system in accordance with the invention;

FIG. 6 is a top view of a tandem assembly showing hydraulic connections and additional non-steering wheels;

FIGS. 7A-7F show top views (7A, 7C, 7E) and rear views (7B, 7D, 7F) of a steering kingpin system illustrating a left turn (7A and 7B), a straight or neutral position (7C and 7D) and a right turn (7E and 7F) with respect to a pulled vehicle illustrating an action of the kingpin steering axle system of the invention;

FIG. 8 represents a bottom perspective view of an alternative embodiment of a steerable axle system with mechanically controlled steering;

FIG. 9A is a front perspective view of another embodiment of an assembled steering axle system similar to that illustrated in FIGS. 1-4 adapted to steer a vehicle supported on spaced track assemblies;

FIG. 9B is a reduced top or plan view of the steering axle system of FIG. 9A;

FIG. 9C is an end elevational view taken from FIG. 9B;

FIG. 9D is a rear elevational view of the steering axle system of FIG. 9B;

FIG. 10A is an exploded view of a track arrangement for use with the steering axle system of FIGS. 9A-9D;

FIG. 10B is a perspective view of the track arrangement of FIG. 10A assembled with the track belt removed;

FIGS. 10C, 10D and 10E are top, end and side views of the assembled track of FIG. 10B;

FIG. 10F is an internal side view with parts removed of the assembled track and the track belt in place showing tensioning central devices, a damping cylinder, and bogey wheel pivot members;

FIGS. 11A-11C are perspective, and enlarged top and rear elevation view of a steering axle and dual track assembly in accordance with the invention assembled with track belts removed;

FIGS. 12A-12D are rear perspective, top, rear elevation and side elevation views of a vehicle frame supported on spaced, steered, dual track arrangements;

FIGS. 13A-13C depict the operation of a track carriage on flat and uneven terrain (shown with the track removed;

FIG. 14A is a top view of a further embodiment of an assembled steering axle system shown in a turning configuration;

FIG. 14B is a top view of the assembly of FIG. 14A shown in a straight aligned configuration;

FIGS. 15A and 15B are top rear perspective views of the assembled steering axle system of FIGS. 14A and 14B shown in a turning and straight aligned configuration, respectively;

FIGS. 16A and 16B are bottom rear perspective views of the assembled steering axle embodiment of FIGS. 14A and 14B, depicted in a turning and straight aligned mode, respectively;

FIGS. 17A, 17B, 17C and 17D are top, rear elevation, detail and end views of the assembled steering axle embodiment of FIGS. 14A and 14B showing turning and kingpin mounting angles;

FIGS. 18A-18C depict axle end views corresponding to turning in both directions (A and B) and with straight ahead alignment (c);

FIG. 19 is a schematic diagram of a hydraulic system for coordinating front and rear steering axles in accordance with the invention;

FIGS. 20A and 20B are front perspective views of a manure tank mounted on a steerable track supported chassis assembly and a wheel supported chassis, respectively;

FIG. 21 is a front elevational view of a grain cart mounted on a steerable track chassis;

FIG. 22 is a rear elevational view of the grain cart of FIG. 21; and

FIG. 23 is a right side elevational view of the grain cart of FIG. 22.

### DETAILED DESCRIPTION

In accordance with the following detailed description, several embodiments associated with the present inventive concepts are presented. These embodiments are intended as examples of such concepts, but are not intended to limit the scope of the present invention in any manner as variations within the confines of the inventive concepts may occur to those skilled in the art.

As used herein, the term “axle assembly” refers to a set of opposed spaced assemblies for carrying wheels or track carriages aligned on opposite sides of a vehicle frame, whether or not they are connected by a common member. Thus, the spaced assemblies may enjoy a common axle tube or other possibly unconnected mounting arrangement. The axle assemblies may be steering in which the wheels can pivot about kingpins or non-steering in which the wheels assume a fixed position. Steering axle assemblies include a connecting member or other arrangement to coordinate the turning of both wheels in unison.

FIG. 1 depicts an exploded view of a typical kingpin steering system, generally at 100, which represents one of a pair of opposed symmetrically constructed assemblies that make up a steering axle assembly in accordance with the invention. The kingpin steering system further includes a kingpin receiver assembly 102 and a spindle receiver 104. A spindle and wheel assembly is shown at 106, including a spindle 108 and a wheel 110 mounted on the spindle. The kingpin receiver assembly further includes spaced, generally parallel, kingpin receiving members 112 and 114, which hold and position an angled kingpin 116 and also accommodate the spindle receiver 104. They also provide bearing surfaces for the assembly to operate. A lip seal member is shown at 118 on the lower bearing surface and a nut 120 secures the kingpin in place. It should also be noted that the nut clamps the upper plate 112 to the lower plate 114 causing the load of the weight of the unit to be carried more evenly.

The spindle receiver 104 includes an integral hollow spindle tube 122 for receiving a corresponding spindle member 108. The assembly further includes a series of thrust washers 124 that carry the vertical load of the vehicle and an o-ring 126 that is mounted beneath the thrust washers to seal the upper bearing surface from the environment. An attachment plate 128 cooperates with members 130 using fasteners (not shown) to attach the assemblies 104 and 106 together.

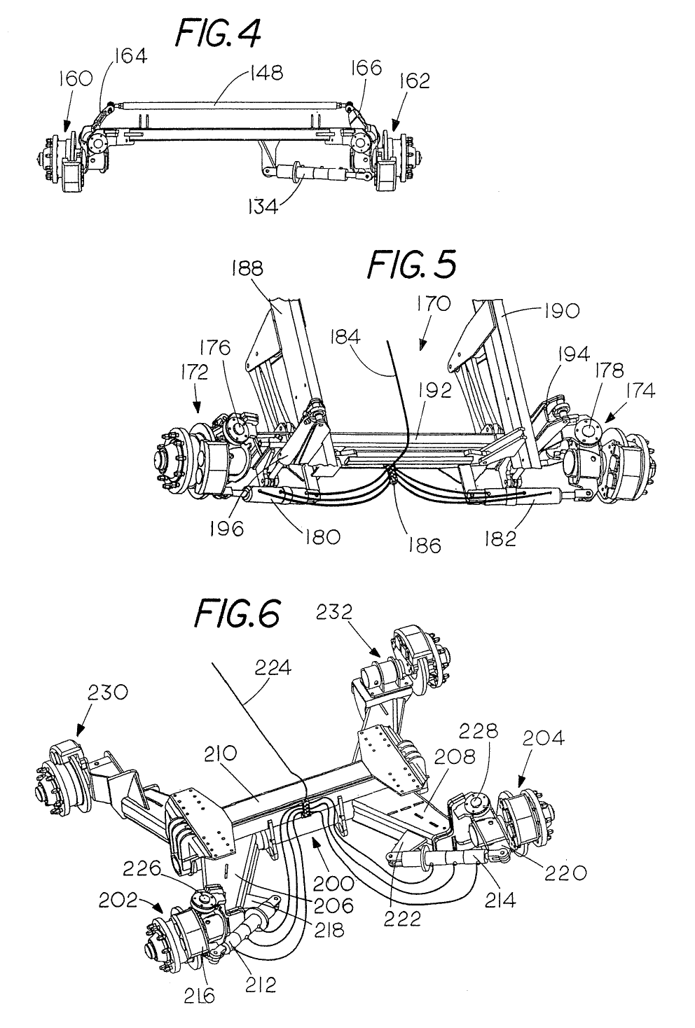

In this embodiment, the kingpin receiver assemblies are attached by intermediate structural members to a common central axle member or axle tube 132 and a fluid-operated, preferably hydraulic, steering cylinder 134 is provided having the rod end 136 mounted to the spindle receiver 104 using tab 138. The other end of the cylinder is connected to a member 140 fixed to the axle tube 132, as shown in FIG. 4.

The hydraulic cylinder 134 is actually a damping cylinder which performs two functions. First, it controls the speed at which the steering system turns and, second, the hydraulic cylinder has three hydraulic connections at 142, 144 and 146 and is pressurized to center the steering system, that is, it urges the system to assume a neutral or aligned straight forward position to allow the unit to back up or to be transported down a road easily, for example, with the spindles in what amounts to a locked position.

This embodiment also includes a tie rod 148 connected between the spindle receivers 104, one connector of which is shown at 150. The tie rod forces the spindle receivers to operate (pivot) in unison by mechanical connection.

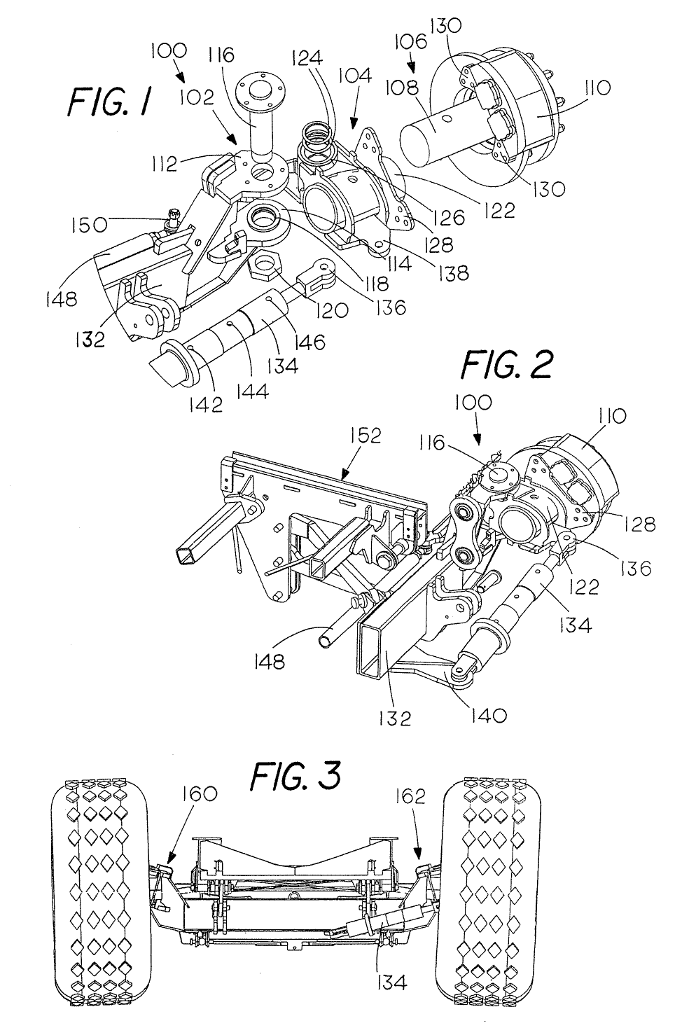

The system of FIG. 1 is shown assembled in FIG. 2 and attached to a fragment of a vehicle frame at 152.

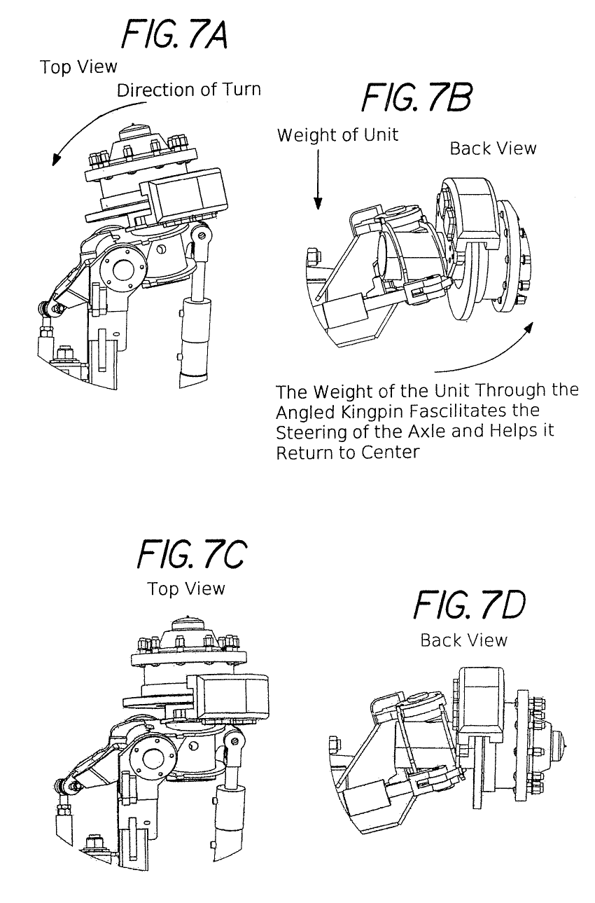

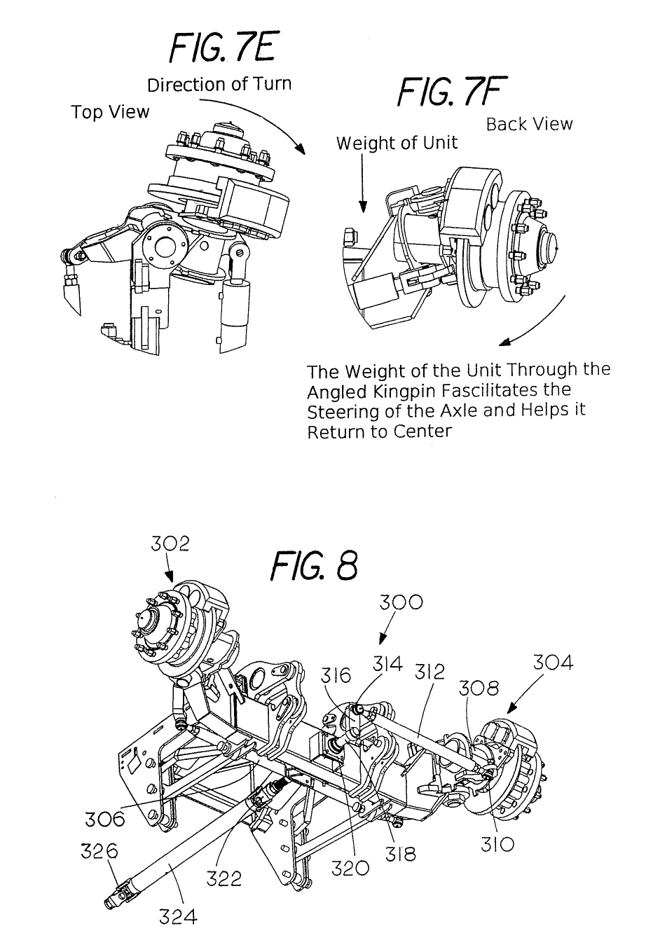

FIGS. 3 and 4 show rear elevational and top views of steering axle assemblies in accordance with the embodiment of FIGS. 1 and 2. As can be seen from the figures, a key feature of the kingpin steering system of the invention lies in the mounting disposition of the kingpins. The kingpins are disposed at a compound acute angle with the common axle tube or other support member such that the kingpins are disposed to extend in a rearward and inward manner rather than being mounted in a conventional vertical plane. An important aspect of the invention is the mounting of the kingpins at a compound angle that allows the spindles to travel in an arc that wants to pivot up and forward with the weight of the unit resting on the bearing surfaces. The tie rod 148 that connects the left kingpin steering system, including the left spindle assembly, shown at 160 in FIGS. 3 and 4, with the right kingpin steering system 162 using respective connectors 164 and 166, as shown in FIG. 4 causes the spindles to operate in unison. This is further illustrated in the turning, straightening and opposite direction turning sequences depicted in FIGS. 7A-7F. Easy turning and relief of stress on the kingpins is accomplished as the spindle receivers, and so the spindles rotate in a plane perpendicular to the non-vertical disposition of the kingpins, rather than in a flat trajectory accommodated by the normal vertical disposition of kingpins.

In addition, this configuration reduces ground traveling in turns and further enables the vehicle to accommodate larger tires, typically up to two meters in diameter or greater, thereby reducing ground loading even more.

FIG. 5 is a top view of an alternative embodiment of an assembled single steering axle system in accordance with the invention. The steering axle is shown generally at 170 and includes spaced symmetrically opposed and otherwise identical kingpin steering assemblies for steering as at 172 and 174 that include compound angled kingpins 176 and 178 respectively. The kingpins are attached to the frame and coordinated by two separate hydraulic cylinders 180 and 182 supplied from a common hydraulic fluid line 184 and common connector 186. The common hydraulic connection enables the cylinders 182 and 182 to act in the manner of a tie rod to coordinate the turning of assemblies 172 and 174 as was the case with the damping cylinder of FIGS. 1-3, the cylinders 182 and 182 act to return the assemblies to a forward directed position. Fragments of frame members are shown at 188 and 190 with cross brace 192 and shock absorbing suspension devices are shown at 194 and 196.

FIG. 6 is a top view of a tandem axle assembly also showing similar hydraulic connections. The steering axle assembly is shown generally at 200 and includes steering spaced, opposed symmetrically constructed kingpin assemblies at 202 and 204. These assemblies are attached to structural members 206 and 208, respectively, which, in turn, attach to a common structural member 210. This system also features a pair of hydraulic steering cylinders 212 and 214. Cylinder 212 connects a corresponding pivoting spindle receiver 216, to a structural member 206 using a plate member 218. Likewise, cylinder 214 connects pivoting spindle receiver 220 with member 208 using a member 222. The cylinders 212 and 214 are provided with hydraulic fluid from a common source 224 in a manner that coordinates both cylinders to operate together and also pressurizes the cylinders to center to stabilize the steering system so that it favors locking the spindles in a forward position.

In this embodiment, note that the kingpins 226 and 228 are disposed at the same angle as those enumerated with respect to the previously described embodiments. Additional non-steering or fixed position assemblies are shown at 230 and 232, which are also structurally attached to the forward portion of common member 210 through an intermediate structure. As can be seen from the drawing, the assemblies 230 and 232 are fixed in a neutral or straightforward position.

FIG. 8 represents a bottom perspective view of an alternative embodiment of a steerable axle system that employs mechanically controlled steering. The system, shown generally at 300, includes angled kingpin steering systems at 302 and 304 with common tie rod 306. The kingpin steering system 304 includes a spindle receiver 308 connected at 310 to a second tie rod 312 which, in turn, is attached at 314 to an eccentric steering arm 316 instead of to a hydraulic cylinder, as shown in the embodiment of FIGS. 1-4, for example. The steering arm 316 is attached to a steering shaft 318 that rotates and operates the eccentric steering arm 316. The shaft 318 is held by bearings as at 320 and extends to be connected by a universal joint 322 to a drive line shaft 324. The drive line locks and controls the amount of steering available in the axle system and is, in turn, connected via a second universal joint 326 to the draw bar of a tractor or other motorized pulling vehicle. In this manner, the act of the tractor turning transfers the necessary torque to the steering axle to rotate the system in the correct amount in the direction. Both kingpin assemblies are coordinated via the connection with common tie rod 306 and the kingpins are set at an angle as per previous embodiments.

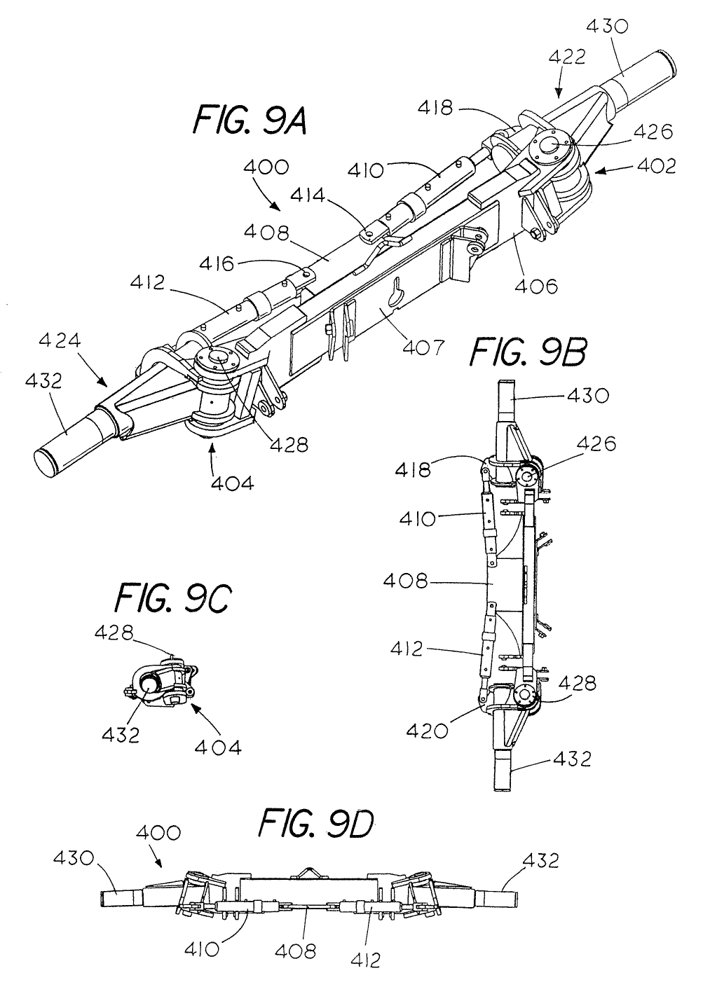

Another embodiment of a steering axle system in accordance with the invention is depicted in FIGS. 9A-9D. That system is adapted to steer a vehicle supported on pairs of spaced track assemblies rather than wheels. The steering axle is shown generally at 400 and includes a pair of spaced compound-angled kingpin receiving arrangements 402 and 404 which are similar to those depicted in FIGS. 1-4 mounted to an axle assembly which includes a tube or common central structural axle member 406 and plate member 407. This embodiment uses a hydraulic coordinating system which includes a central plate member 408 secured to structural member 406 and pivotally connected to the blind ends of a pair of hydraulic cylinders 410 and 412 at 414 and 416. The rod ends of cylinders 410 and 412 are pivotally connected to gusset plate members 418 and 420, respectively, which are connected to spindle assemblies 422 and 424 and operate to pivot the spindle assemblies in unison based on a fluid control system, as will be described, to control the speed at which the steering system turns. The fluid control system also may coordinate to turn both axles of a dual axle steering system and to urge the system to assume a neutral or aligned straight forward position when desired. The spindle assemblies 422 and 424 pivot about dual angled kingpins 426 and 428 and carry heavy integral spindle steering rod members 430 and 432, respectively. FIG. 9D depicts the relative inward directed angles of the kingpins about which the spindles rotate. The preferred angles of the kingpins are also discussed further below.

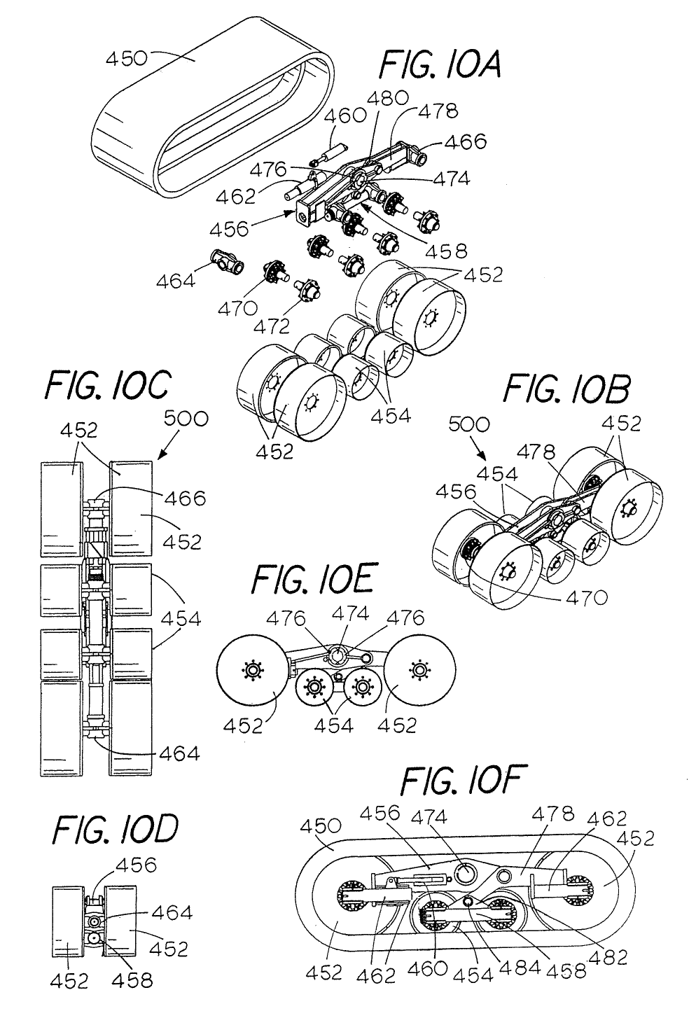

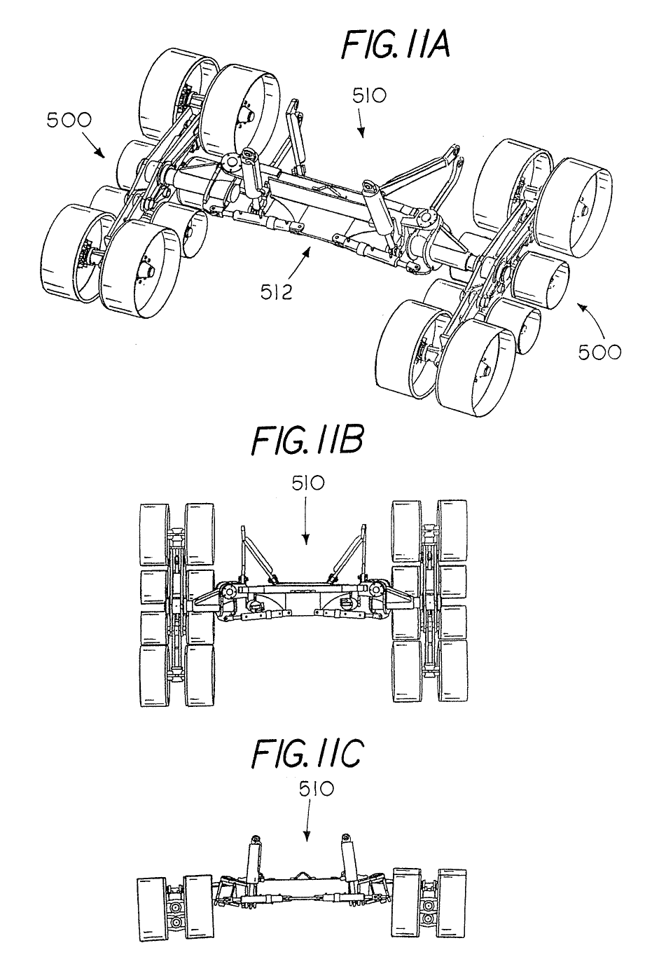

FIG. 10A depicts an exploded view of one track arrangement in accordance with the invention. The track is one of a pair of spaced steered track assemblies which are designed to be associated with and connected to an axle assembly such as that shown in FIGS. 9A-9D. The assembly includes a track belt 450, which may be a continuous belt. One model uses a belt that is thirty-six inches (91.4 cm) wide made of heavy gauge rubber. Pairs of spaced idler wheels 452 which may be 30 inches (76.2 cm) in diameter flank pairs of spaced bogey wheels 454, which may be 16 inches (40.6 cm) in diameter, and these are combined to operate each inside track belt 450.

The assembly further includes a track carriage main arm 456 with associated bogey rocker arm 458, hydraulic tension adjusting and damping cylinder 460, track tensioning spindles 462, front and rear track arm members 464 and 466. Opposed hub members 470 and 472 are associated with each pair of spaced idler and bogey wheels.

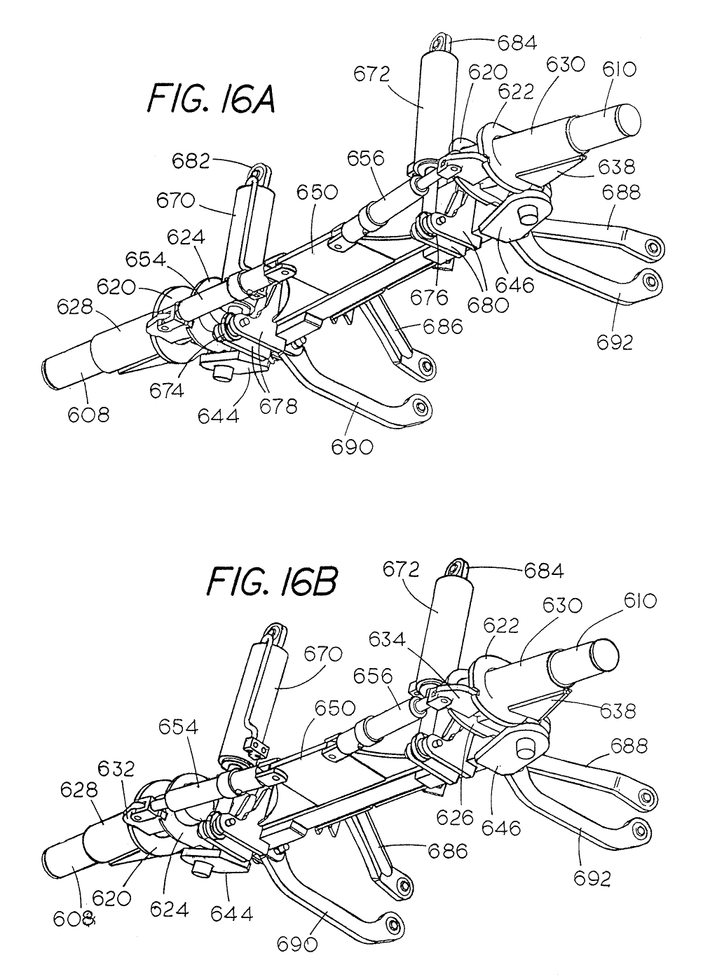

The track carriage main arm 456 includes a steering spindle receiving opening 474 flanked by a pair of half ring retaining members 476. Main arm 456 further includes a connected pivoting section 478 connect to pivot at 480. The pivoting connection of the two arm sections enables the two outer sets of idler wheels 452 to be displaced up and down relative to each other in response to uneven ground. As best depicted in FIGS. 10F and 13A-13C, the sets of bogey wheels are carried and connected by bogey rocker arm 458 which, has an attached gusset 482 that, in turn, is pivotally connected at 484 to pivoting connecting arm member 478 which, as indicated, is pivotally connected to main arm 456 at 480. This arrangement enables the sets of bogey wheels 454 to pivot in unison and independent of the sets of idler wheels 452 in response to uneven ground making the entire track quite flexible.

The terrain following versatility characteristic of the track assemblies of the invention is illustrated in FIGS. 13A-13C which depict a track on level ground 490 in FIG. 13A, and on different uneven ground patterns in FIGS. 13B (492) and 13C (494).

FIGS. 10B-10F depict views of the track arrangement of FIGS. 10A in assembled form at 500 with the track belt removed except in the view of FIG. 10F which illustrates the internal workings including the damping cylinder and track tensioning devices which are located between the pairs of spaced idler and bogey wheels.

FIGS. 11A-11C illustrate perspective, top and rear elevation views of a pair of track modules similar to those of FIGS. 10A-10F assembled with a steering axle into a steerable dual track unit 510 including a steering axle 512 connecting a pair of assembled track arrangements 500 shown with the track belts removed for clarity. The modular track arrangements are connected to be steered by the heavy spindle rod members of the steering axles. A plurality of such units are used as undercarriage supports for the chassis frame of a heavy grain cart, manure tank or the like.

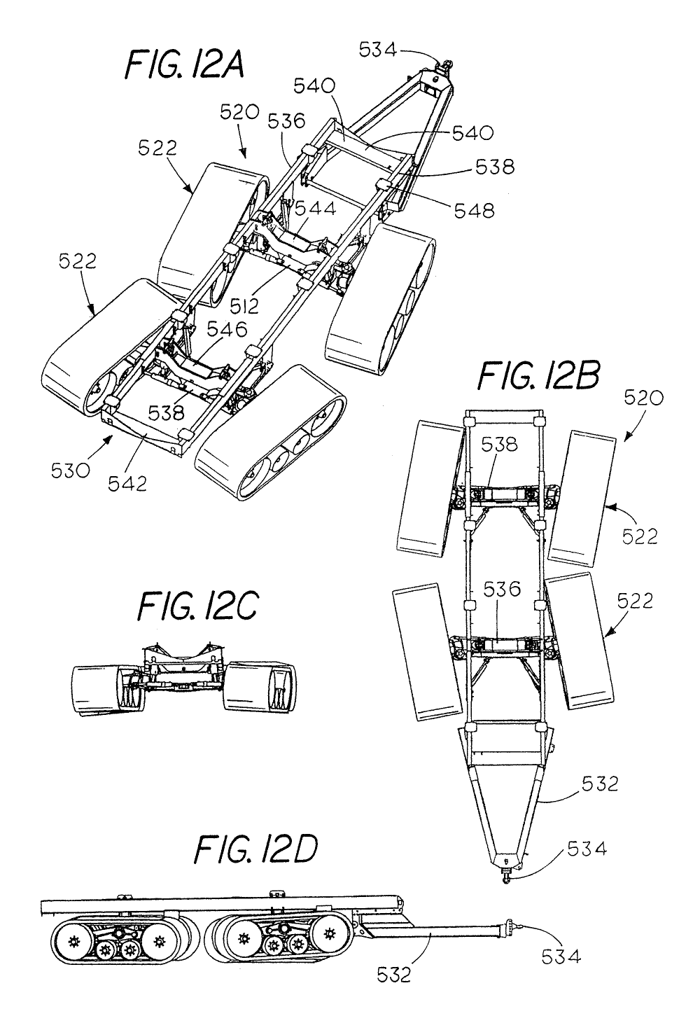

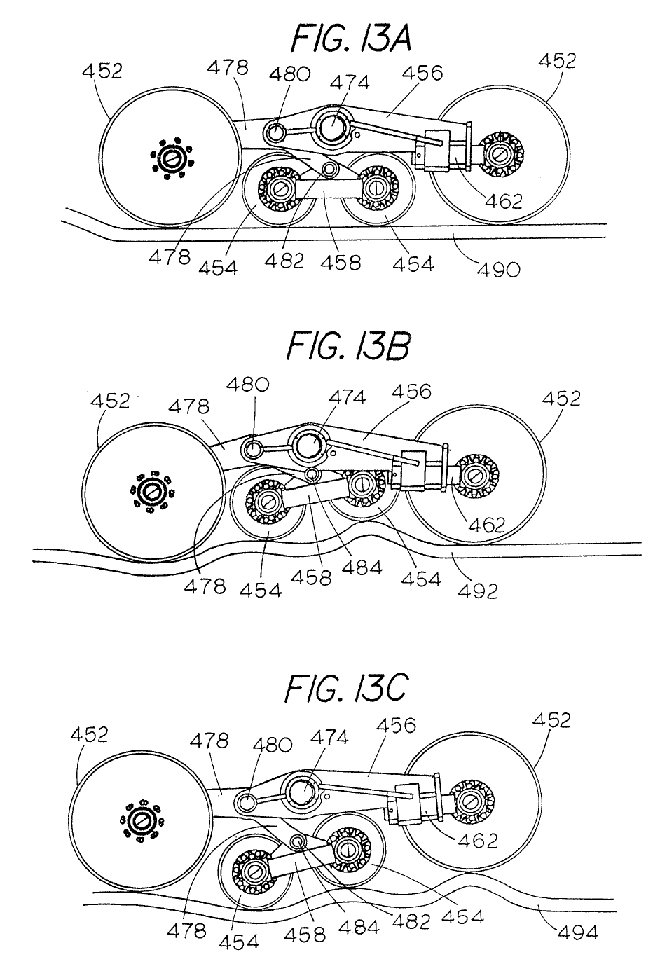

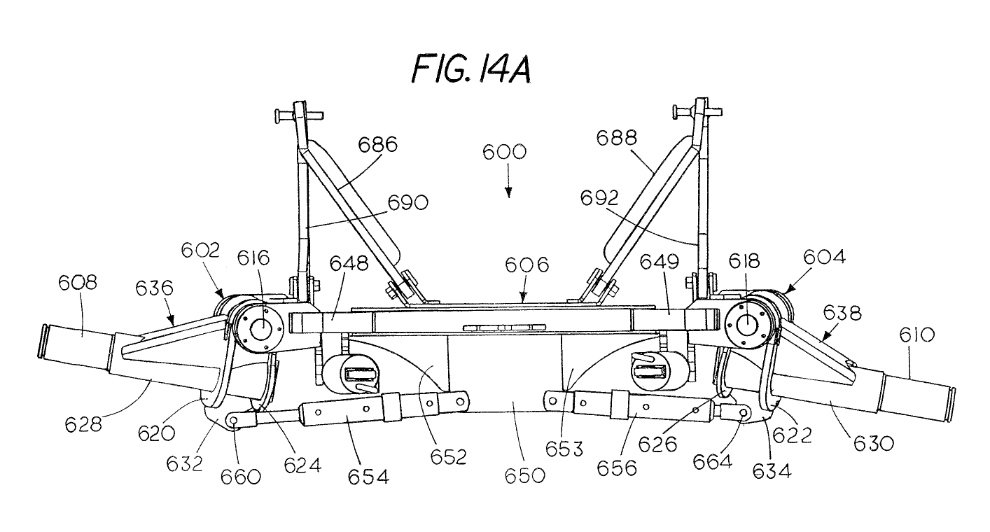

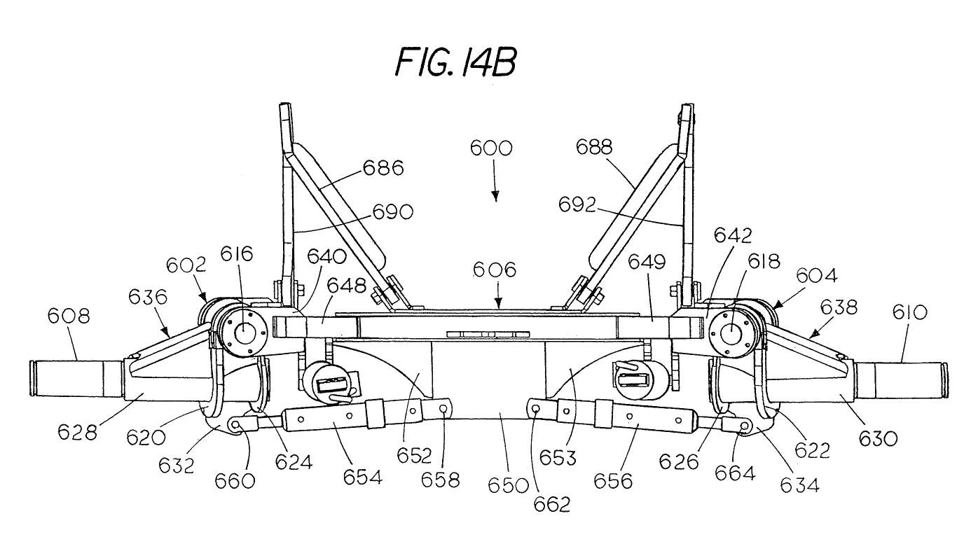

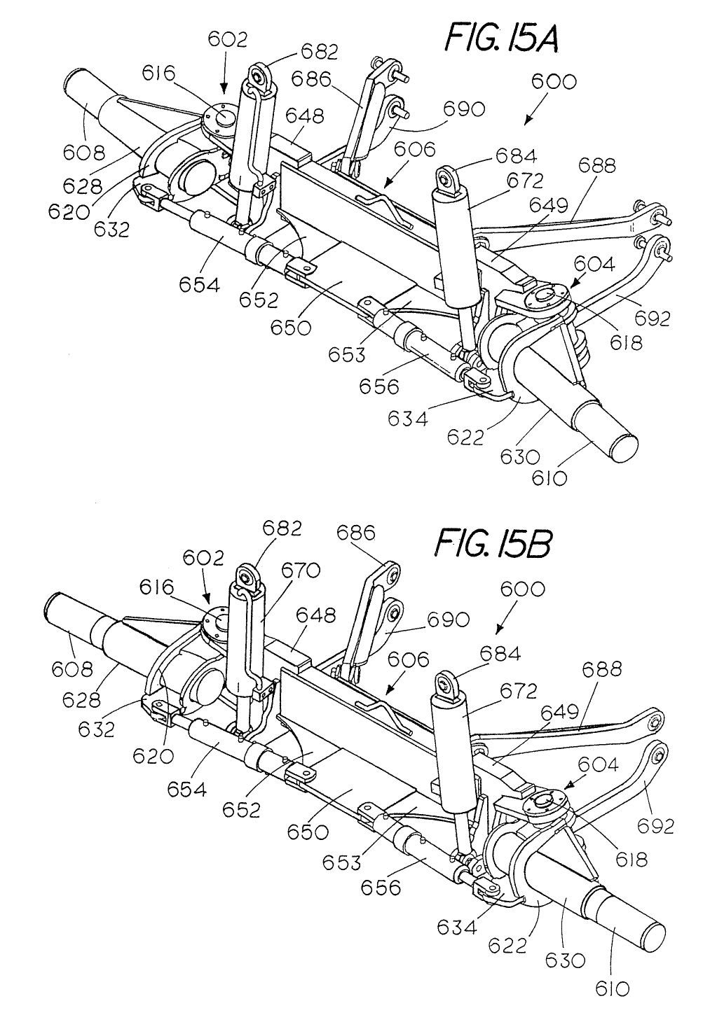

FIGS. 12A-12D show perspective, top, end elevation and side elevation views of an assembled vehicle 520 without a mounted container, but including a plurality of steerable track modules assembled with belts or treads in place at 522 in spaced relation with steering axles 512 to form dual track units. Spaced dual track units provide undercarriage support to support a heavy structural frame or chassis 530 for a heavy container such as a manure tank grain cart or similar heavy container.

Thus, FIG. 12A is a perspective view of an assembled vehicle 520 suitable for carrying a grain cart, manure tank or similar large, heavy vehicle implement unit including the tracks, chassis 522, frame 530 and a yoke assembly 532 with a hitch 534 for attachment to a farm tractor or other towing vehicle. The heavy structural frame 530 is attached to an undercarriage arrangement that includes spaced front and rear spaced self-steering axle assemblies 512 which, connect between and steer the pairs of spaced track assemblies 522. The chassis frame 530 further includes main longitudinal support members 536 and 538 spanned by end transverse cross members 540 and 542 and shaped intermediate cross members 544 and 546. The cross members 544 and 546 are shaped to receive the lower portion of a grain cart or tank body or the like. Support pads are shown at 548.

In this illustrated embodiment, both sets of track assemblies are steering sets which gives the vehicle the most flexibility for maneuvering in an agricultural field. Other embodiments of the vehicles can be built in which only one of the dual track sets or units, self steers. In addition, the number of steerable or fixed dual track sets can be varied depending on the vehicle size. The views depict the vehicle in a turning disposition in which the front and rear dual track units turn in opposite directions to aid in reducing the overall turning radius of the vehicle. This feature is described in greater detail below.

An important aspect of the track-mounted embodiment is that it provides a combination of large area support for the unit in the form of a plurality wide track supports which reduces the unit area loading and thus reduces soil compaction; but it also provides a self-steering aspect to the track assemblies that avoids the undesirable and destructive effects of skid steering conventionally present with track supported vehicles.

The large self-steering footprints of the tracks also enable the use of grain carts, manure tanks or similar vehicles that carry larger payloads without increasing soil compaction or disruption. Thus, ten or twelve thousand (10,000-12,000) gallon tanks weighing over 100,000 lbs. (45,351 kg) fully loaded or 2500 bushel grain carts can easily be accommodated. For example, each track may present a footprint surface 36 inches (91.4 cm) wide by 72 inches (183 cm) long or 18 ft² or 2592 in² (1.67 m²). In this manner, a load of 100,000 lbs. (45,351 kg) supported on four track units yields a per square inch in loading of only about 9.65 lbs. (4.14 kg) per in². This is much lower loading than would be available with conventional tires, which present a much smaller footprint or contact area, and therefore allows a much higher vehicle capacity at a comparable soil loading.

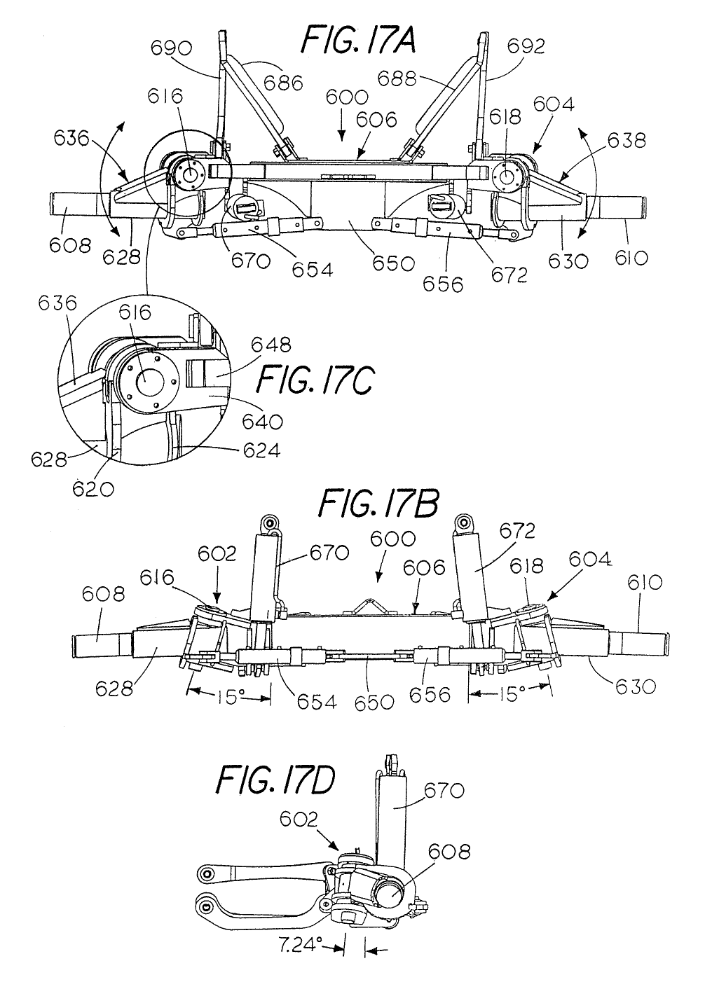

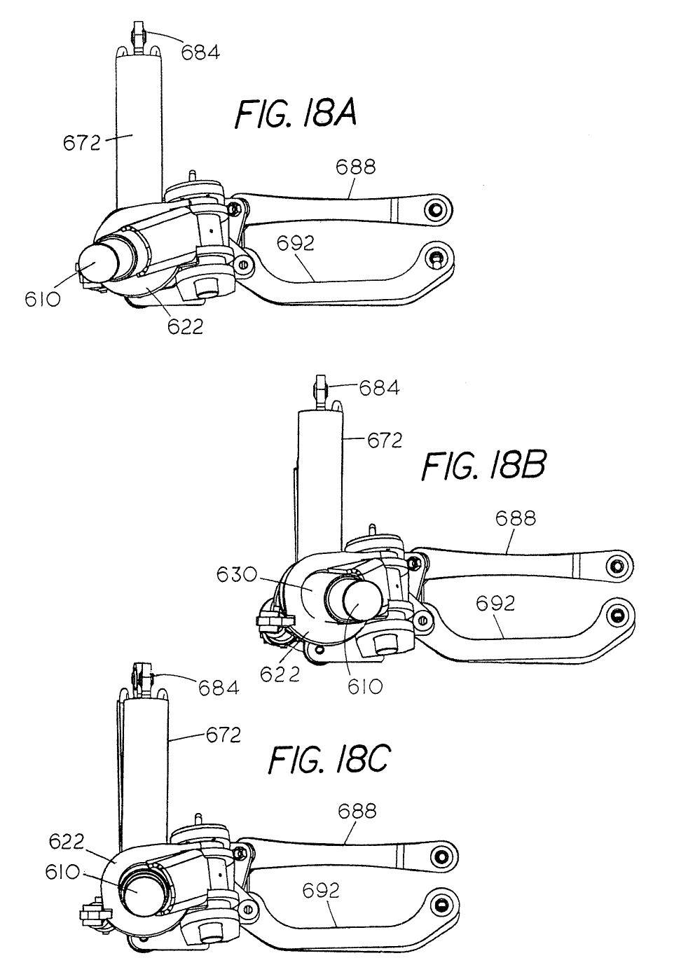

FIGS. 14A through FIG. 18C depict a variety of views of an arrangement of steering axles and details or fragments similar to that shown in FIGS. 9A-9D. A steering axle assembly is shown generally at 600 in a turning configuration in FIGS. 4A, 15A and 16A, and in a straight tracking disposition in FIGS. 14B, 15B and 16B. Similar to other embodiments, the steering axle assemblies 600 include compound-angled kingpin receiving arrangements 602 and 604 mounted at the ends of a common axle tube or heavy central structural axle assembly 606. In this embodiment, a pair of heavy round spindle steering rod members 608 and 610 are carried in reinforced mounting structures in the form of spindle receiver assembles 612 and 614 that are mounted to rotate about kingpins 616 and 618, respectively. These are similar to assemblies 104, 160, 216, etc. previously described. As with previously described embodiments, the spindle receiver structures are identical opposed structures located at the ends of the axle assembly 606 and include a pair of shaped members in the form of an outer member 620, 622 and an inner member 624, 626 that carry and fasten an outer tube 628, 630 to the assembly. Heavy plate members 632, 634 are fixed to the shaped members. Reinforcing gusset structures 636, 638 stabilize the structure. The kingpin receiving arrangements 602 and 604 are connected to the central structural axle assembly by heavy retaining members that include top members 640 and 642 and bottom members 644 and 646 (FIGS. 16A and 16B). These, in turn, are connected to the central structural axle assembly 606 by heavy shaped connecting members 648 and 649.

A reinforced central plate member 650 is connected to the main structural axle assembly reinforced by opposed reinforcing side gussets 652, 653. Each steering axle includes a pair of fluid operated double-acting cylinders 654 and 656 which are pivotally attached between plate member 650 and plate members 632 and 634, respectively, with the rod ends connected to plates 632 and 634. Thus, cylinder 654 includes a base or blind end pivotally attached to plate 650 at 658 and a rod end pivotally attached to a plate 632 at 660 and cylinder 656 has a base or blind end pivotally attached to plate 650 at 662 and a rod end pivotally attached to a plate 634 at 664. Each cylinder includes three fluid connections, a rod connection (R), a base connection (B) and a common connection (C) that function as will be described.

Each steering axle also includes a pair of spaced heavy shock-absorbing container support arrangements shown at 670 and 672 with connections at 674 and 676, respectively, between sets of plates 678 and 680, which are fixed to the main axle assembly 606. The members 670 and 672 are designed to connect to a grain cart, bin or tank support structure. The support arrangements 670 and 672 are, thus, pivotally mounted to the axle assembly arrangement 606 at their bottom ends and include top connectors 682 and 684. Pairs of inner and outer chassis connecting shaped strut members 686, 688 and 690, 692 connect the axle assembly to chassis members.

FIGS. 17A-17B depict top and rear elevational views of the axle assembly of FIGS. 14A and 14B. FIGS. 17C and 17D depict certain details. FIG. 17B shows a kingpin side angle directed toward the center of the axle of 15° from vertical and FIG. 17D shows a kingpin angle of 7.24° from the vertical toward the rear of the axle assembly. The inward directed angle of the kingpins distributes a portion of the vertical weight of the vehicle as a horizontal force which, in turn, assists the turning rotation of the spindle rod steering members 606 and 608 when the vehicle turns according to the direction of travel of the towing vehicle. The rear-directed angle assists in returning the axle to straight tracking after a turn. While an angle of about 15° inward directed kingpin angle and an angle of about 7°, preferably 7.24°, rearward directed appears to be optimal, inward directed angles in the range of from about 13° to about 17° produce satisfactory results and a rearward directed angle in the range of 6° to 9° will also produce satisfactory results.

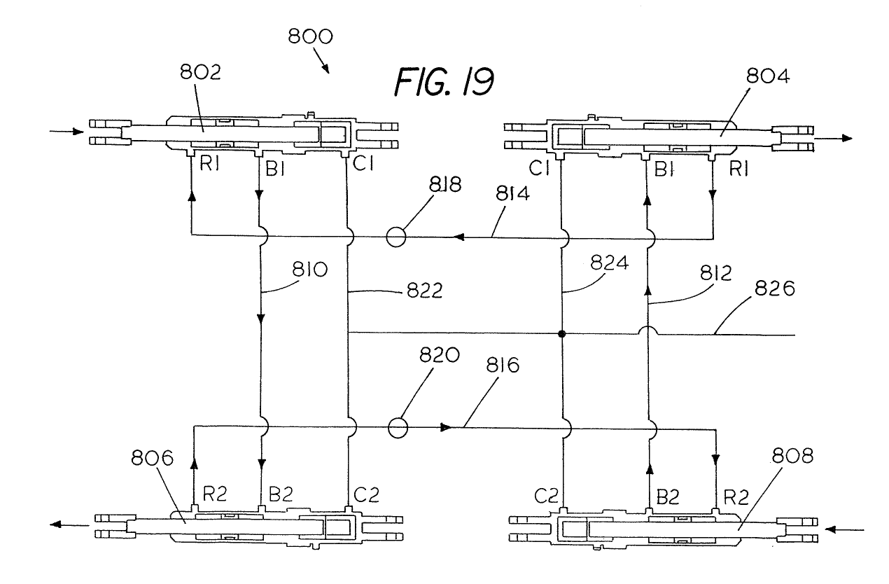

FIG. 19 depicts a schematic drawing of a hydraulic system diagram for coordinating the steering of an embodiment of a track vehicle having two spaced steering axles as shown in FIGS. 12A-12D. A front vehicle axle includes double-acting cylinders 802 and 804 and a rear axle includes double-acting cylinders 806 and 808. The axles are configured as in the embodiment of FIGS. 14A-14B.

Each of the corresponding front and rear cylinders has three port connections including a rod end port connection (R), a base end port connection (B) and a common port connection (C). The ports of front steering axle cylinders are designated R1, B1 and C1, and the ports of rear steering axle cylinders are designated R2, B2 and C2. The base ends of front and rear cylinders 802 and 806, shown on the left side of the schematic drawing, and 804 and 808, shown on the right side of the schematic drawing, are connected together by respective lines 810 and 812. The common parts are likewise connected by lines 822 and 824. The rod ends of front axle cylinders 802 and 804 are connected together by a common line 814; likewise the rod ends of rear axle cylinders 806 and 808 are connected together by a common line 816. Optionally, fluid accumulators represented at 818 and 820 may be included in lines 814 and 816 respectively to dampen unequal external effects in the terrain encountered by the vehicle. The front axle cylinders and rear axle cylinders through their rod end and base end connections form a closed loop system that operates to coordinate the steering of the front and rear axles as will be explained. As indicated, connections Cl and C2 of cylinders 802 and 804; and cylinders 809 and 808 are connected together by lines 822 and 824, respectively. Lines 822 and 824 are both connected to a common source of high pressure hydraulic fluid in line 826.

In operation and according to the schematic view of FIG. 19 in which fluid flow is denoted by arrows, both the front and rear axles are in the process of steering the vehicle to the left. The rod end of cylinder 804 extends causing fluid to be displaced into line 814. The fluid enters port R1 of cylinder 802 to retract rod end of cylinder 802. The combination causes both of the associated front tracks to turn to the left. This action also displaces fluid into line 810 from the base port of cylinder 802 to the base port of cylinder 806 which causes rod end of cylinder 806 to tend to extend. This, in turn, displaces fluid into line 816 from port R2 of cylinder 806 and into port R2 of cylinder 808 causing the rod end to retract. Fluid is displaced from the base port B2 of cylinder 808 to the base port B1 of cylinder 804, along line 812, accordingly. Thus, the rear tracks turn to the right. The result is that the front axle is caused to turn to the left and the rear axle is caused to turn to the right as illustrated in FIGS. 12A-12D, as viewed from the rear of the illustrated chassis. The simultaneous turning of both axles greatly reduces the overall required turning radius of the vehicle. In a right turn situation, the opposite flow will occur. When the turn is completed the steering axles will straighten on their own.

High pressure fluid line 826 is used to lock the front and rear axles in a straight position when this is required, as for allowing an empty vehicle to be backed when required.

As with other embodiments, the angled kingpins of the track-mounted vehicle will cause the axles to track in a straight line until the prime moving pulling tractor or other motorized vehicle changes direction to a sufficient degree to overcome the two kingpin angles. It is the weight of the vehicle on the self-steering mechanism that provides the force for the axle to steer the tracks in the direction urged by the pulling vehicle. In the preferred arrangement, both axles steer thereby greatly reducing the turning radius of the tank or cart or other heavy container carried on the chassis.

The coordination of the cylinder system of each axle keeps the tracks on a common axle coordinated or in tune as well as would occur with a solid connecting rod while also allowing some variation or cushioning in the system. As indicated, the fluid system further causes the rear axle to turn in a direction opposite to that of the front axle thereby doubling the degree of turning obtained to reduce the overall turning radius of the vehicle. Accumulators provide a degree of damping in the system. It will also be appreciated that the accumulators may be used to enable a greater variation between the amount of turning angle of the front and rear axles to accommodate field obstacles or other problems that prevent identical degrees of turning for both front and rear track systems.

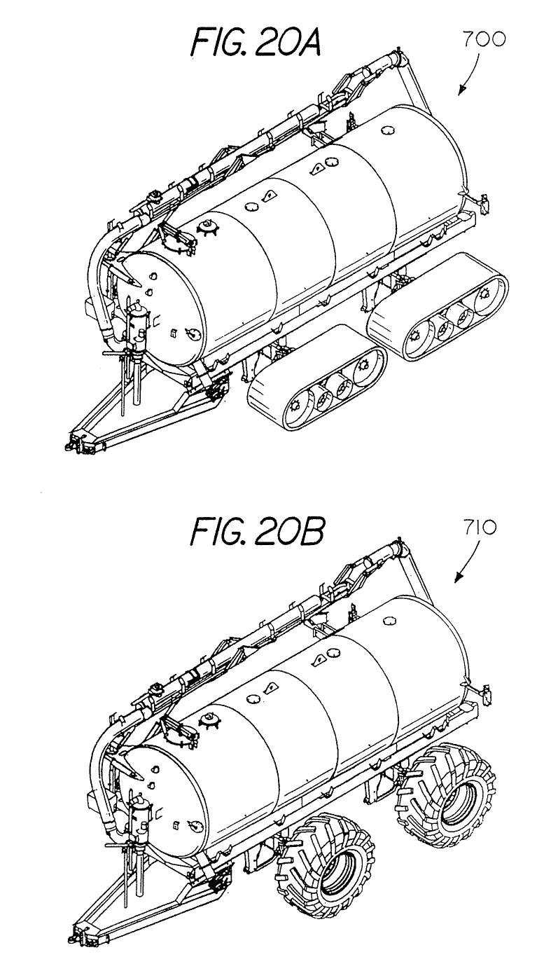

FIG. 20A shows a perspective view of a fully assembled manure tank vehicle 700 mounted on a dual steerable track chassis system in accordance with the invention. FIG. 20B shows the same type of implement at 710 mounted on a steerable wheeled system. The greatly increased ground contact surface of the track system is evident.

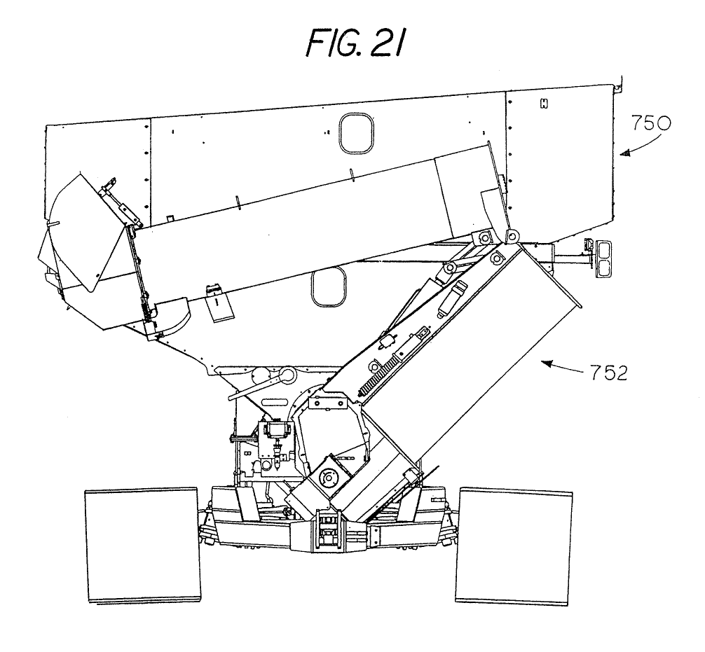

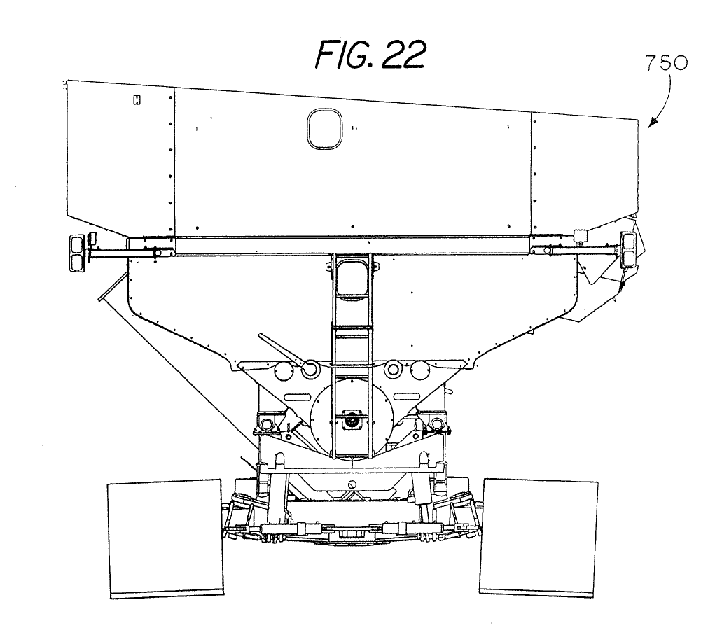

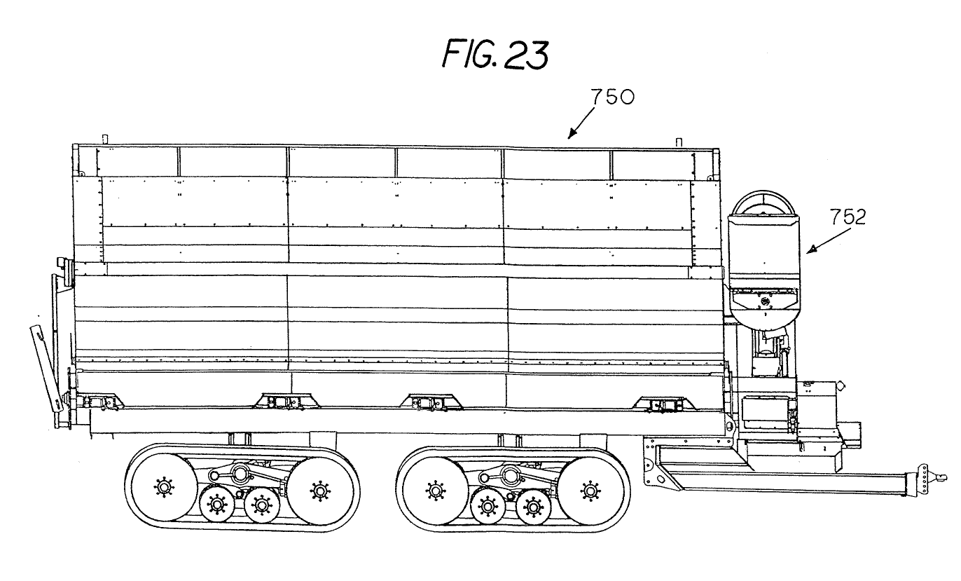

FIGS. 21-23 depict front, rear and side views of a vehicle according to the invention in the form of a grain cart body 750 mounted on a steerable track vehicle chassis. As previously indicated, the grain cart, when loaded, weighs many tons and the track system aids in both turning and reducing local ground loading. An unloading assembly is shown at 752.

It will be appreciated that the steering axle track-mounted arrangement of the present invention lends itself for use with any combination of steering and non-steering axles in grain carts and manure tanks or the like designed to be pulled in a forward direction by a motorized conveyance.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A self-steering agricultural vehicle of a class including grain carts and manure tanks designed to be pulled by a farm tractor, or the like, comprising:
(a) a frame for supporting a load and an attached undercarriage arrangement including a plurality of axle assemblies;
(b) wherein at least one axle assembly is a self-steering axle assembly further comprising:
(1) a pair of spaced kingpin receiver arrangements supported by a common central axle and a spindle assembly carried by each kingpin receiver and a spindle rod member mounted in each spindle assembly, each said spindle rod member being adapted to connect to a track assembly;
(2) a kingpin mounted in each kingpin receiver, each kingpin receiver being configured such that a kingpin mounted therein is disposed at a fixed compound acute angle with the common central axle member, said angle being both directed inward toward said central axle member and rearward of said central axle member, each spindle receiver being adapted to pivot about a kingpin according to said compound angle;
(3) a spindle assembly connecting system for causing said spindle assemblies to operate in unison to coordinate axle steering;
(4) wherein said kingpin angle causes an outward spindle rod member to travel in an arc that pivots upward and forward in a turn thereby facilitating the turning of the self-steering axle; and
(c) a pair of spaced track assemblies connected to each of said axle assemblies, a track assembly being connected to each spindle rod member of said at least one self-steering axle to pivot with said spindle rod member for turning a connected track assembly thereby steering said vehicle.

2. A self-steering agriculture vehicle as in claim 1 wherein said connecting system comprises hydraulic cylinders connected to said spindle receivers.

3. A self-steering agriculture vehicle as in claim 1 wherein said vehicle comprises two axles.

4. A self-steering agriculture vehicle as in claim 3 wherein two of said vehicle axles are self-steering axles.

5. A self-steering agriculture vehicle as in claim 1 wherein each kingpin is inclined at a side angle of about 13°-17° with the vertical inward and at a rearward angle of about 6° to go with the vertical of said central axle member when said vehicle is on a level surface.

6. A self-steering agriculture vehicle as in claim 5 wherein the rearward angle is about 7.24°.

7. A self-steering agriculture vehicle as in claim 1 wherein said vehicle includes front and rear self-steering axles, wherein said spindle assembly connecting system in each self-steering axle includes a pair of opposed hydraulic cylinders connecting said spindle assemblies with a central member and wherein the cylinders of the front self-steering axle are connected to coordinate with the cylinders of the rear self-steering axle such that the front and rear axles turn in opposite directions during a vehicle turn.

8. A self-steering agriculture vehicle as in claim 5 wherein said vehicle includes front and rear self-steering axles, wherein said spindle assembly connecting system in each self-steering axle includes a pair of opposed hydraulic cylinders connecting said spindle assemblies with a central member and wherein the cylinders of the front self-steering axle are part of a coordinated system connected to coordinate with the cylinders of the rear self-steering axle such that the front and rear axles turn in opposite directions during a vehicle turn.

9. A self-steering agriculture vehicle as in claim 5 wherein said side angle is about 15°.

10. A self-steering agriculture vehicle as in claim 6 wherein said side angle is about 15°.

11. A self-steering agriculture vehicle as in claim 7 further comprising an accumulator associated with each self-steering axle to dampen cylinder action.

12. A self-steering agriculture vehicle as in claim 7 further comprising a fluid system for optimally locking the cylinders of both said front and said rear self-steering axles in position to align said tracks in a straight disposition for control in backing said vehicle.

13. A self-steering vehicle as in claim 2 wherein said connected system coordinating system comprises a closed hydraulic system.

14. A self-steering agriculture vehicle as in claim 1 wherein each said kingpin receiver further comprises spaced upper and lower plates and a thrust washer assembly and wherein each said spindle receiver assembly is mounted therebetween to rotate about said kingpin.

15. A self-steering agriculture vehicle as in claim 8 further comprising an accumulator associated with each self-steering axle to dampen cylinder action.

16. A self-steering agriculture vehicle as in claim 8 further comprising a fluid system for optimally locking the cylinders of both said front and said rear self-steering axles in position to align said tracks in a straight disposition for control in backing said vehicle.

17. A self-steering agriculture vehicle as in claim 1 wherein said load is selected from grain cart and manure tank bodies.

18. A self-steering agriculture vehicle as in claim 5 wherein said load is selected from grain cart and manure tank bodies.

19. A self-steering agriculture vehicle as in claim 1 wherein each of said track assemblies comprises two pairs of spaced bogey wheels flanked by two pairs of spaced idler wheels, said wheels being contained in a flexible track and a device to adjust tension in said track.

20. A self-steering agriculture vehicle as in claim 19 wherein said idler wheels are mounted in a manner that enables the pairs of spaced idler wheels to pivot generally vertically relative to each other to adjust to uneven terrain.

21. A self-steering agriculture vehicle as in claim 19 wherein said two pairs of bogey wheels are mounted together on a pivotally mounted bogey rocker arm for pivoting in response to uneven terrain.

22. A self-steering agriculture vehicle as in claim 20 wherein said two pairs of bogey wheels are mounted together on a pivotally mounted bogey rocker arm for pivoting in response to uneven terrain.

23. A self-steering agriculture vehicle as in claim 1 wherein each said track assembly comprises a track carriage main arm that carries said track assembly and that further comprises a spindle rod receiving opening and ring retainers for retaining said spindle rod in said main arm, wherein said spindle rod pivots said main arm to steer said track.

24. A self-steering agriculture vehicle as in claim 22 wherein each said track assembly comprises a track carriage main arm that carries said track assembly and that further comprises a spindle rod receiving opening and ring retainers for retaining said spindle rod in said main arm, wherein said spindle rod pivots said main arm to steer said track.

25. A self-steering agriculture vehicle as in claim 19 further comprising a clamping cylinder in said track assembly that tends to maintain said idler wheels in a level disposition.

26. A self-steering agriculture vehicle as in claim 24 further comprising a damping cylinder in said track assembly that tends to maintain said idler wheels in a level disposition.

27. A self-steering agricultural vehicle of a class including grain carts and manure tanks designed to be pulled by a farm tractor, or the like, comprising:
(a) a frame for supporting a load and an attached undercarriage arrangement including front and rear axle assemblies;
(b) wherein both said front and rear axle assemblies are self-steering axle assemblies further comprising:
(1) a pair of spaced kingpin receiver arrangements supported by a common central axle member and a spindle receiver assembly carried by each kingpin receiver and a spindle rod member mounted in each spindle receiver assembly, each said spindle rod member being adapted to connect to a track assembly;
(2) a kingpin mounted in each kingpin receiver, each kingpin receiver being configured such that a kingpin mounted therein is disposed at a fixed compound acute angle with the common central axle member, said angle being both directed inward toward said central axle member about 13°-17° from the vertical and rearward of said central axle member about 6°-9° from the vertical when said vehicle is on a level surface, each spindle receiver being adapted to pivot about a kingpin according to said compound angle;
(3) a fluid-operated spindle assembly connecting system for causing spindle receivers of an axle assembly to operate in unison and said front and rear axle assemblies to coordinate such that the front and rear axles turn in opposite directions during a vehicle turn;
(4) wherein said kingpin angle causes an outward spindle to travel in an arc that pivots upward and forward in a turn thereby facilitating the turning of the self-steering axle; and
(c) a pair of track assemblies connected to each self-steering axle assembly, a track assembly being connected to each spindle rod member of said self-steering axle to pivot with said spindle rod for turning a connected track assembly steering said vehicle.

28. A self-steering agriculture vehicle as in claim 27 wherein said load is selected from grain cart and manure tank bodies.

29. A self-steering agriculture vehicle as in claim 28 wherein said vehicle includes front and rear self-steering axles, wherein said spindle assembly connecting system in each self-steering axle includes a pair of opposed hydraulic cylinders connecting said spindle assemblies with a central member and wherein the cylinders of the front self-steering axle are connected to coordinate with the cylinders of the rear self-steering axle such that the front and rear axles turn in opposite directions during a vehicle turn.

30. A self-steering agriculture vehicle as in claim 28 wherein said spindle assembly connecting system further comprises an arrangement for causing the front and rear axles to lock into a straight disposition.
